(19) United States
(12) Patent Application Publication
(10) Pub. No.: US 2012/0067185 A1
(43) Pub. Date: Mar. 22, 2012

(54) CIRCULAR CROSS-CUT SAW

(76) Inventor: Gerhard Weusthof, Schapen (DE)

(21) Appl. No.: 13/319,757

(22) PCT Filed: May 4, 2010
(86) PCT No.: PCT/EP2010/002724

§ 371 Date: Nov. 10, 2011

(30) Foreign Application Priority Data
May 11, 2009 (DE) 10 2009 020 717.1

(51) Int. Cl. B27B 5/29; B23D 45/04; B27G 19/04

(52) U.S. Cl. 83/397

(57) ABSTRACT

A circular cross-cut and miter saw has a supporting table and a sawing device, which is pivotable about a cross-cutting axis and has a saw blade and a movable swing guard. During a cross-cutting movement of the sawing device, a swivel mechanism produces a pivoting and/or swiveling movement of the swing guard such that the swing guard can be at least partly opened by swinging the sawing device down and closed by swinging the sawing device up. Uncomfortable and dangerous handling of the swing guard during the cross-cutting movement is avoided by a locking element of the swivel mechanism disposed such that the swing guard can be opened still further, even completely, by hand or by a workpiece to be cut, if either the locking element has been actuated or the cross-cutting movement has already been at least partially carried out.

The invention relates to a circular cross-cut saw, in particular a miter saw, having a supporting table and having a sawing device, wherein the sawing device is arranged so as to be pivotable about a cross-cutting axis, wherein the sawing device has a saw blade and a displaceable swing guard and a pivoting mechanism is provided, wherein during a cross-cutting movement of the sawing device, a rotating and/or pivoting movement of the swing guard is realizable via the pivoting mechanism in such a manner that the swing guard can be opened by pivoting down the sawing device and can be closed by pivoting up the sawing device.

Workpieces can be cut to size on a supporting table using a cross-cut saw. Using a miter saw, workpieces, in particular workpiece bars, can be cut to size at an angle deviating from a right angle—the miter angle. A sawing device with a rotatably arranged sawing blade is arranged on an arm above the supporting table for sawing the workpiece. The arm, in the case of a miter saw, is pivotally mounted on a rotating means so as to be pivotable about a vertical axis so as to be operatively effective. The miter angle can be adjusted by pivoting the arm by way of the rotating means. In addition, the arm is preferably pivotable about a mitering axis, wherein the mitering axis extends substantially perpendicular with respect to the pivot axis, namely in a workpiece plane or cutting plane. A securable pivot joint can be provided for this purpose between the arm and the rotating means. Once, where applicable, the mitering angle has been set, the workpiece can be cross-cut or sawn through by way of the sawing device, for which purpose the sawing device can be lowered down for a cross-cutting movement.

In an upper position of the sawing device, the saw blade is covered by a swing guard. The cross-cut saw also has a pivoting mechanism such that the cross-cutting movement of the sawing device is coupled with the pivoting movement of the swing guard in such a manner that the swing guard can be opened by pivoting down the sawing device and can be closed by pivoting up the sawing device.

DE 60307557 T2 makes known a cross-cut saw having a supporting table, with a bearing block arranged pivotably on the supporting table and with an arm arranged pivotably on the bearing block. The arm supports a sawing device with a motor housing, with a motor arranged in the motor housing, with a saw blade driven by the motor, with a blade guard which covers an upper part of the saw blade, and with a swing guard which is mounted so as to be rotational or pivotable on the blade guard in order to cover a lower part of the saw blade. The arm, in this case, is mounted so as to be pivotable on a bearing block in order to enable a cross-cutting function. A connecting rod connects the swing guard to the bearing block such that when the sawing device pivots downward, in order to cut a workpiece arranged on the supporting table, the swing guard is rotated and releases the saw blade. In addition, in this case, a guard locking mechanism is provided in order to prevent unwanted release of the saw blade by the swing guard. The guard locking mechanism, in this case, consists of a lever arranged so as to be pivotable on the upper blade guard, wherein the lever is provided with teeth. The swing guard has corresponding teeth which can be brought into meshing engagement with the teeth of the lever. In the case of this guard locking mechanism, the teeth of the lever contact the teeth of the swing guard when the sawing device is arranged in the upper position. When a user tries to move the sawing device down, he is prevented from doing so as the meshing teeth prevent this. The user is only able to move the sawing device down when he pivots the lever up, as a result of which the teeth are moved out of engagement and the swing guard is thereby unlocked. The disadvantage of this is that before the cross-cutting movement is carried out, the guard locking mechanism has to be actuated, as a result of which, on the one hand, the user of the cross-cut saw is diverted from the precise execution of the cross-cutting movement of the sawing device, and on the other hand the amount and content of the labor for the user is greatly increased.

DE 2829297 A1 makes known a cross-cut saw with a supporting table, with an arm and with a sawing device arranged on the arm. The sawing device, in this case, has a housing for the drive of a rotating saw blade, said housing being pivotable by means of a handle. In an upper position, the saw blade is covered by a swing guard, which is pivotable in opposition to a spring force. When the lever is pivoted, the swing guard, by way of a tensile connection, is then pivoted away from the saw blade in opposition to the force of a resetting spring. The lever, in this case, is connected to the swing guard by means of a cable and by means of a cable roller. When the lever is moved down, the swing guard is pivoted away from the saw blade. In the new end position, the lever assumes a position in which, when the lever makes a further pivoting movement, the sawing device is pivoted down onto the workpiece. In this development, the swing guard is first of all opened by the lever and only then is the adjusting movement or cross-cutting movement of the sawing device carried out.

DE 2443550 C3 makes known a generic cross-cut saw with a supporting table and with an arm, wherein a hand-held circular saw is arranged on the arm as the sawing device. The hand-held circular saw has a swing guard which is raised automatically by means of a cable when the sawing device is pivoted down. The arm, in this case, is pivoted with the hand-held circular saw and is connected to the guard of the hand-held circular saw by means of the cable. The swing guard is automatically pivoted away by the pivoting movement during the cross-cut. In this case, it is disadvantageous that a certain return stroke has to be carried out before the saw blade is released. When the saw blade is released, the saw blade is situated just in front of the workpiece.

The circular cross-cut saws known in the prior art are not yet optimally designed. The operating convenience of the circular cross-cut saws known in the prior art is not yet optimally designed as the swing guards have to be partly opened by hand or first have to be unlocked in an awkward manner before the cross-cutting movement can be effected. This can be awkward and very labor intensive for the user when working with the cross-cut saw.

Consequently, the object underlying the invention is to design and further develop a cross-cut saw such that inconvenient handling of the circular cross-cut saw, in particular of the swing guard, is avoided and the risk of injuries is reduced.

The object shown before is now achieved in that the pivoting mechanism has a locking element, wherein the pivoting mechanism and the locking element are arranged and/or realized in such a manner that the swing guard—preferably by hand or preferably by a workpiece provided to be cut—can be opened even further, in particular fully when either the locking element is actuated or the cross-cutting movement has already been carried out at least in part. Consequently, in this case, the only time the locking element has to be additionally actuated in a separate manner, preferably by hand, is when the swing guard has to be opened to change the saw blade. In the normal case, the swing guard is opened sufficiently just by the lowering of the sawing device (downward), that is to say during the cross-cutting movement of the sawing device. In the upper part of the cross-cutting movement, when less than 70%, in particular less than 50% of the cross-cutting movement has been carried out, the swing guard is preferably restrictedly guided, as, if the locking element is not actuated, that is to say is not manually unlocked, the swing guard cannot be opened, preferably by hand, any further, or in particular cannot be opened fully, than the realized restricted guiding allows. The swing guard, however, can be opened in the upper part of the cross-cutting movement when the locking element is manually actuated, namely before being moved into an unlocking position. In the lower part of the cross-cutting movement, when, for example, more than 70% or in particular more than 50% of the cross-cutting movement has been carried out, the swing guard can be opened preferably by hand or by pressing against or by contact with a workpiece to be cut which is supported on the supporting table, without the locking element being additionally actuated. I.e. the locking element blocks manual, additional further opening of the swing guard in an upper part of the cross-cutting movement. In a lower part of the cross-cutting movement, the locking element has no locking function, i.e. additional further opening, in particular full opening of the swing guard by hand or by pressing against or by contact with a workpiece which is supported on the supporting table and is to be cut, cannot be blocked by the locking element in the lower part of the cross-cutting movement. In the final analysis, the swing guard can therefore only be opened further by hand in the upper part of the cross-cutting movement when the user additionally manually unlocks the locking element in the upper part of the cross-cutting movement, that is to say moves it into its unlocking position, or in particular 50% of the cross-cutting movement has already been carried out and the sawing device is pivoted back down again, for from a certain cross-cutting pivot point, the locking element also has no further locking action. The advantage of this pivoting mechanism—realized in this manner—is that automatic unlocking of the swing guard occurs with the cross-cutting movement and no additional buttons or locks have to be actuated. This means that a restrictedly guided swing guard is realized which is locked in the upper part of the cross-cutting movement and unlocked in the lower part of the cross-cutting movement. The further the cross-cutting movement of the sawing device is carried out, the further the swing guard is opened “automatically” even in part. Full or complete opening of the swing guard is possible in the different situations or positions of the sawing device, however preferably only under the following conditions: In the upper part of the cross-cutting movement, full opening is only possible when the locking element is manually actuated at the same time, i.e. in the upper part of the cross-cutting movement, the swing guard has to be “actively” unlocked by the user in order to open the swing guard in part or fully. In the lower part of the cross-cutting movement, the locking element no longer has any function and the swing guard can be opened preferably by hand or by contacting a workpiece, in particular can even then be fully opened, further than is already predetermined by the guided movement. The advantage of this, in addition, is that in the upper portion of the cross-cutting movement an unintended, sometimes full, opening of the swing guard is controlled or made more difficult by the locking element. This means that the risk of injuries by opening the swing guard too prematurely is considerably reduced. In the lower portion of the cross-cutting movement, when the sawing device approaches the workpiece with the sawing blade, without manual actuation of the locking element, the swing guard is able to be pivoted up even further than the opening already predetermined by the restricted guiding, which means that this makes the handling of the swing guard easier. Through the restricted guiding of the swing guard realized in this manner in dependence on the cross-cutting movement of the sawing device, the swing guard is automatically locked in the upper position of the sawing device and is automatically unlocked in the lower position of the sawing device, in particular is preferably unlocked when a cross-cutting movement of the sawing device is already effected which is in excess of 50%, preferably in excess of 70% of the overall cross-cutting pivot region (when viewed from top to bottom). In this case, in the upper position of the sawing device, manually opening the swing guard is prevented on account of the locking or is only made possible when the locking element is separately correspondingly actuated beforehand or is held in the unlocked position, wherein in the “unlocked position” manual—in particular even further—opening of the swing guard is made possible at any time independently of the actuation and/or of the position of the locking element, namely when the cross-cutting movement of the sawing device is already partly carried out and the sawing device is situated in a lower position. The pivoting mechanism realized in this manner or the locking element and its method of functioning can be explained in detail below. As a result, the aforedescribed disadvantages are avoided and corresponding advantages are achieved.

There are a plurality of possibilities for designing and developing further the circular cross-cut saw as claimed in the invention in an advantageous manner. To this end, reference may be made initially to the claims inserted after claim 1. A preferred development of the invention is explained below by way of the drawing of the associated description, in which, in detail:

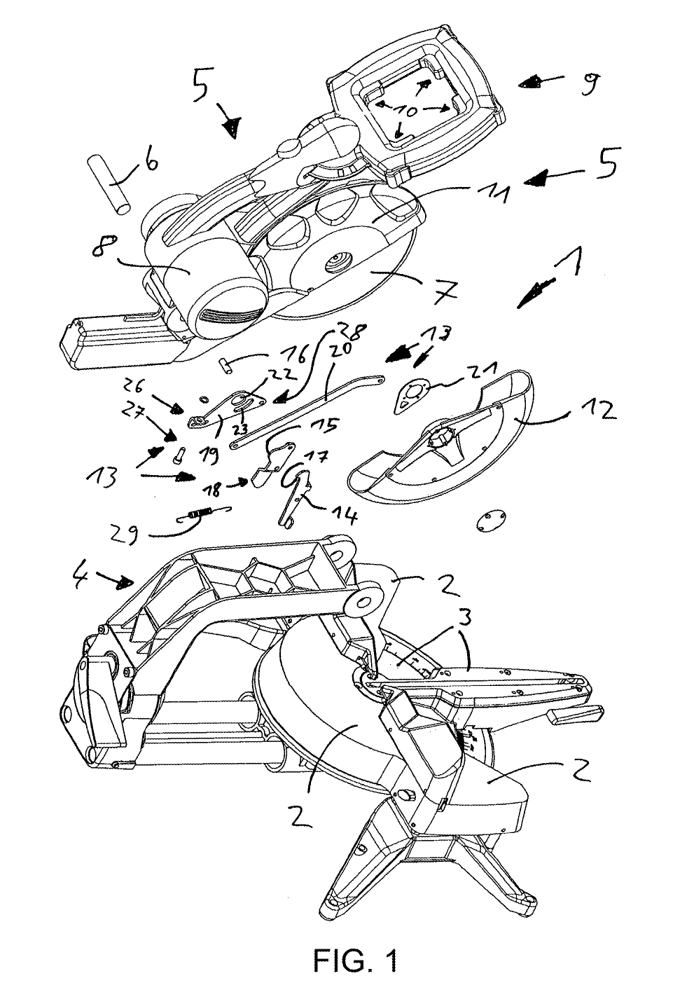

FIG. 1 shows a schematic, perspective, exploded representation of a cross-cut saw with a pivoting mechanism, also shown schematically in an exploded view, for the swing guard or its components,

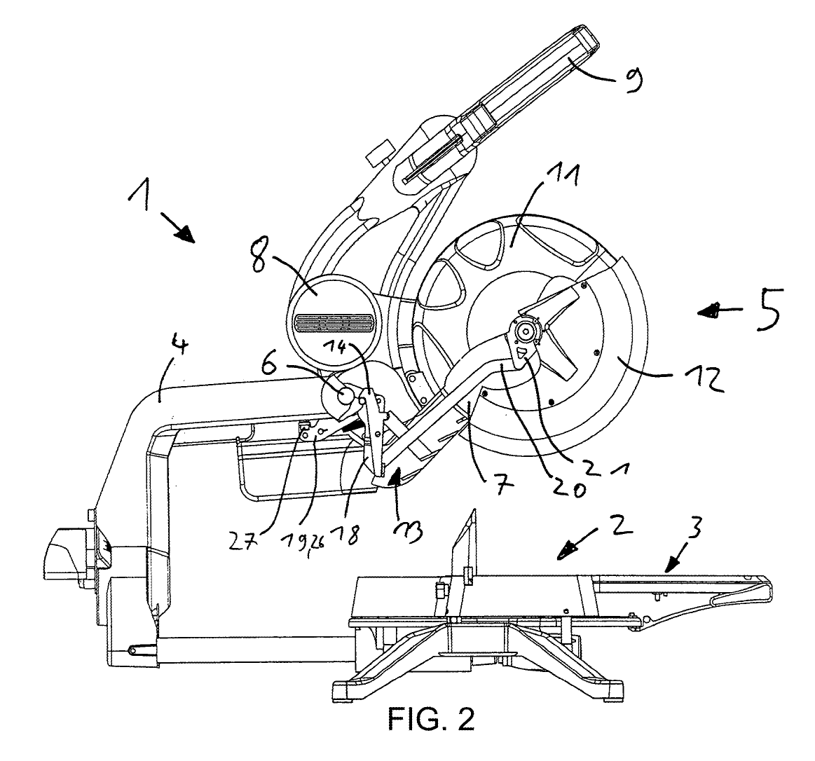

FIG. 2 shows a schematic side view, partly broken open, of the circular cross-cut saw in FIG. 1, with a sawing device in an upper position with the swing guard closed and locked,

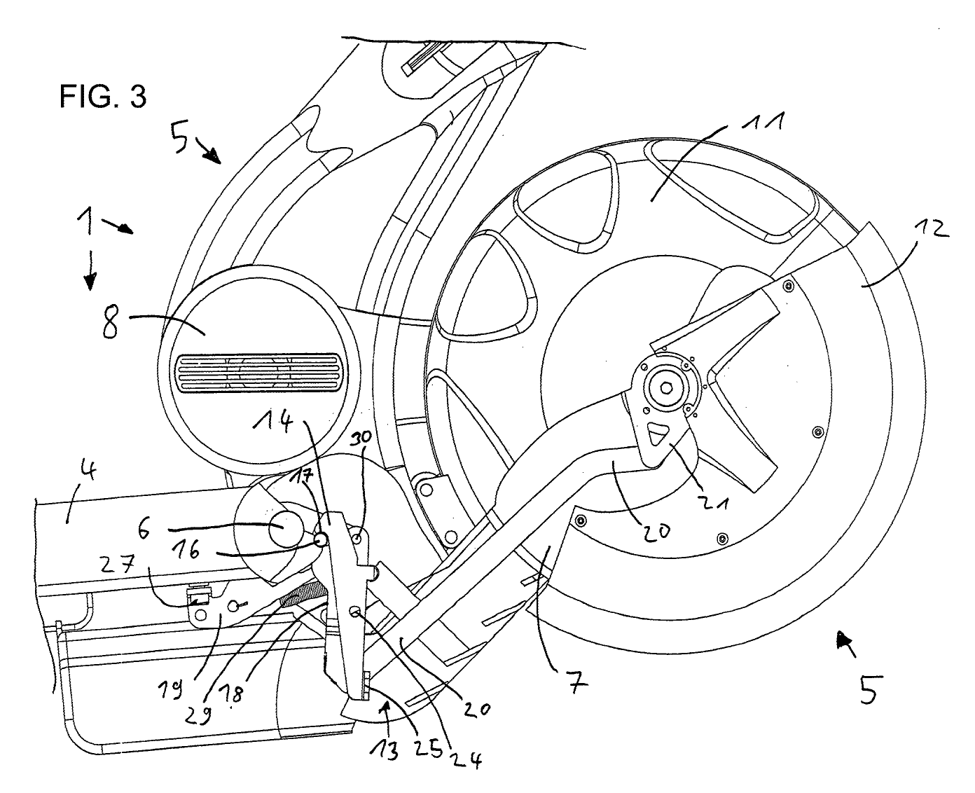

FIG. 3 shows a schematic representation, partly broken open, of a detail of the circular cross-cut saw with the sawing device from FIG. 2,

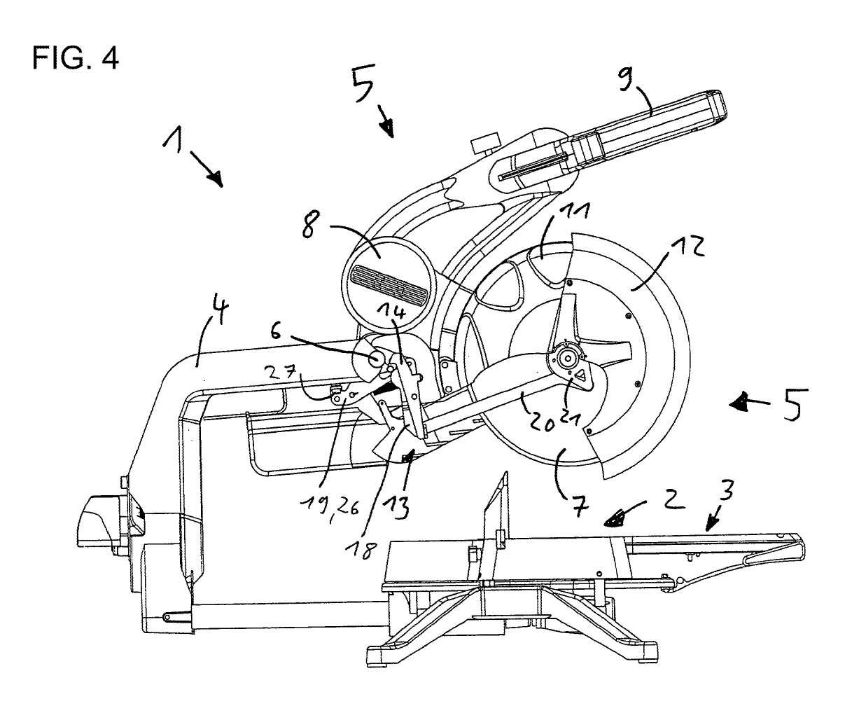

FIG. 4 shows a schematic side view, partly broken open, of the circular cross-cut saw from FIGS. 1 to 3, wherein the sawing device is arranged in a central position or has been pivoted into a central position, with the swing guard partly open,

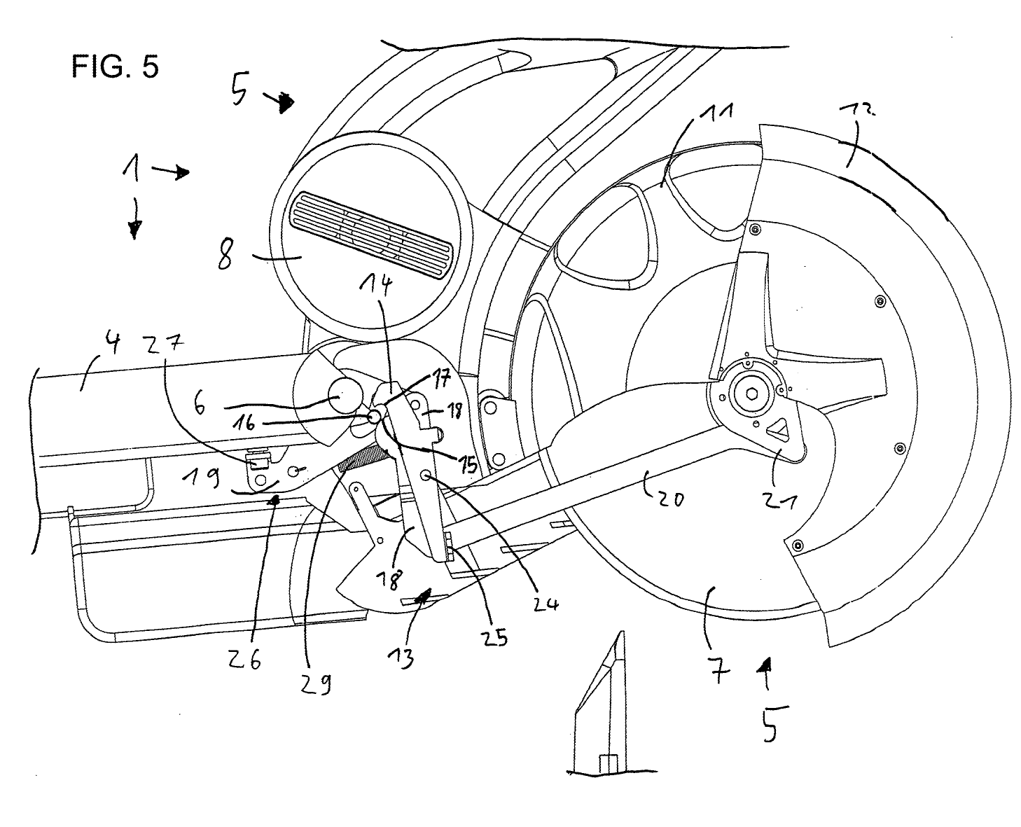

FIG. 5 shows a schematic representation, partly broken open, and side view of a detail of the sawing device in the central position from FIG. 4,

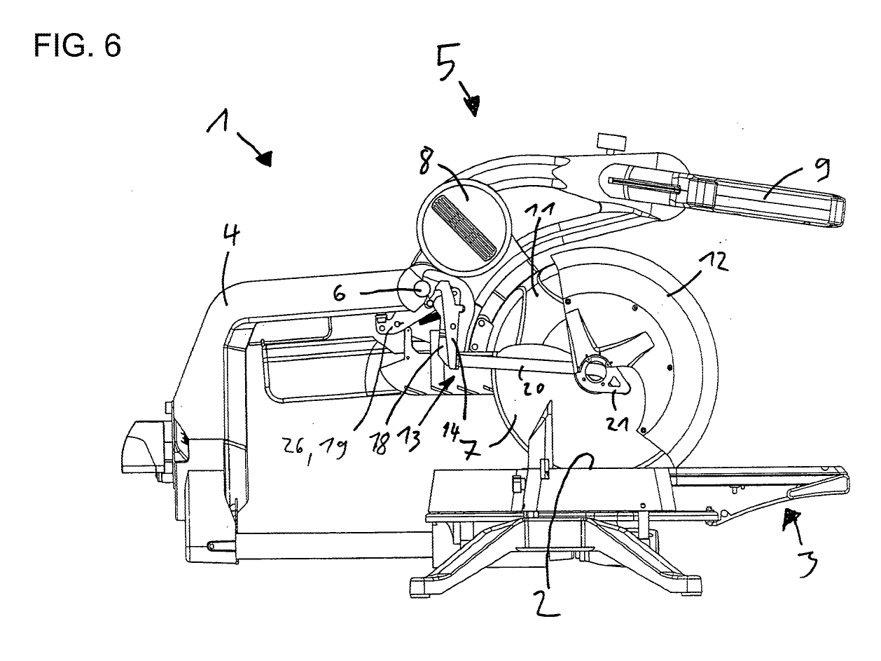

FIG. 6 shows a schematic side view, partly broken open, of the circular cross-cut saw from FIGS. 1 to 5, wherein the sawing device is arranged in a lower position,

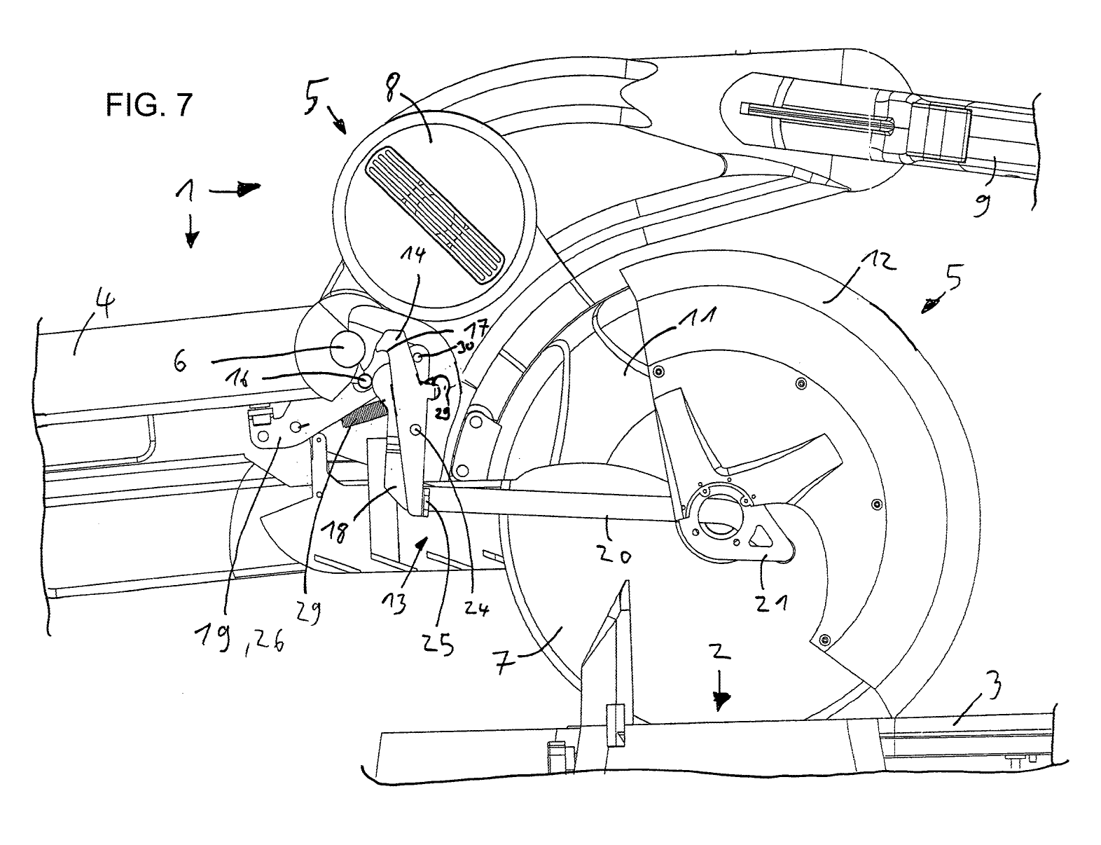

FIG. 7 shows a schematic representation, partly broken open, of a detail of the circular cross-cut saw from FIGS. 1 to 6, wherein the sawing device is arranged or has been pivoted into the lower position shown in FIG. 6,

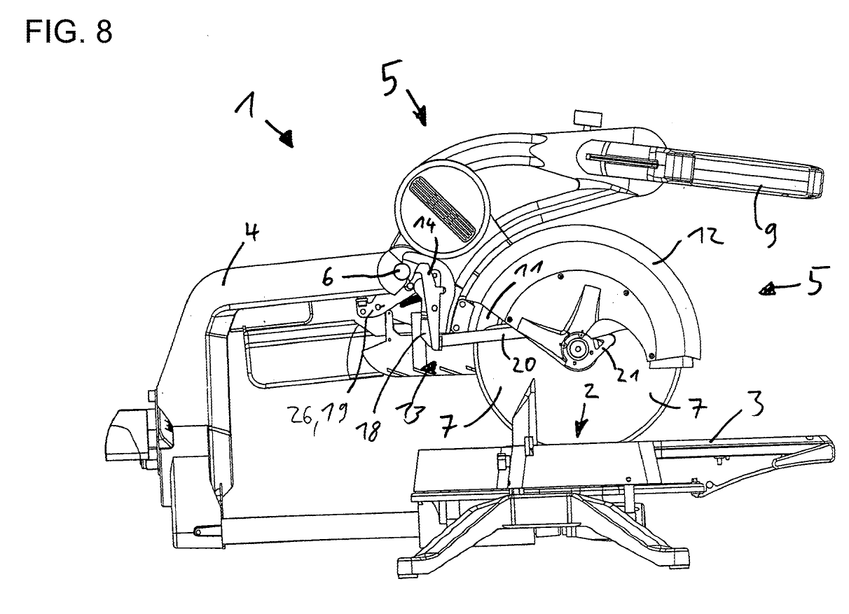

FIG. 8 shows a schematic side view, partly broken open, of the miter saw from FIGS. 1 to 7, wherein the sawing device is arranged in the lower position and a swing guard is shown fully open,

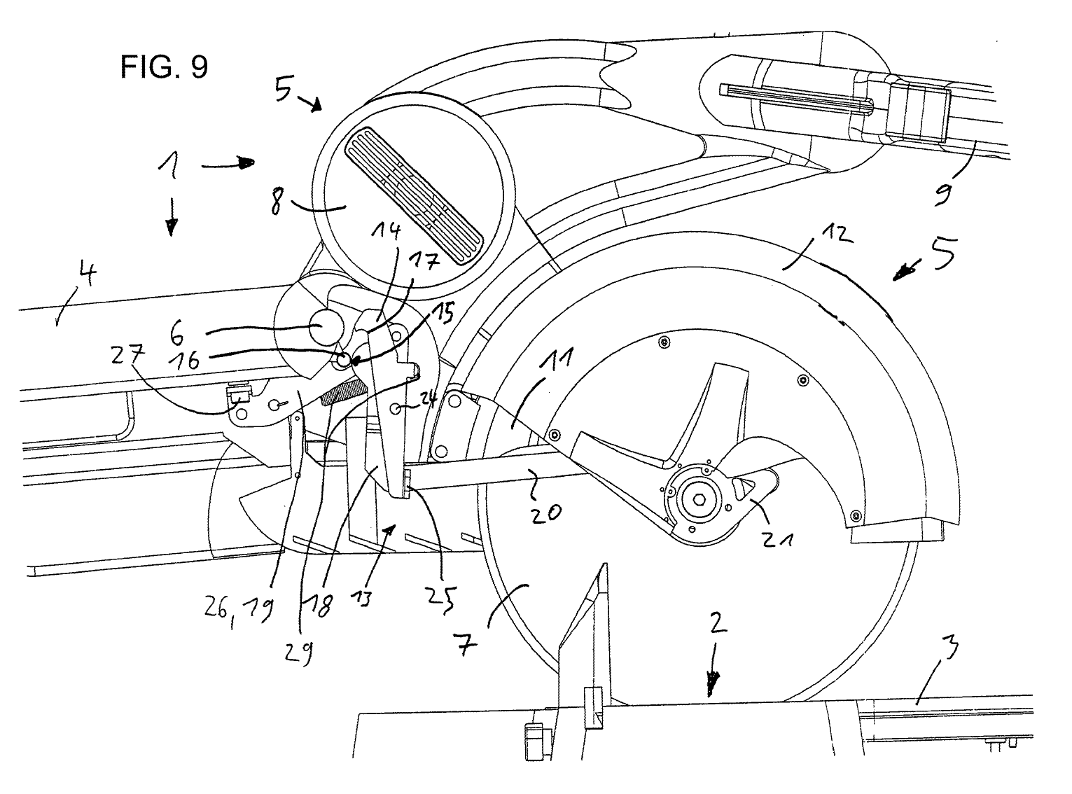

FIG. 9 shows a schematic representation, partly broken open, of a detail of the circular cross-cut saw from FIGS. 1 to 8, wherein the sawing device is arranged in the position shown in FIG. 8 and the swing guard is also fully open,

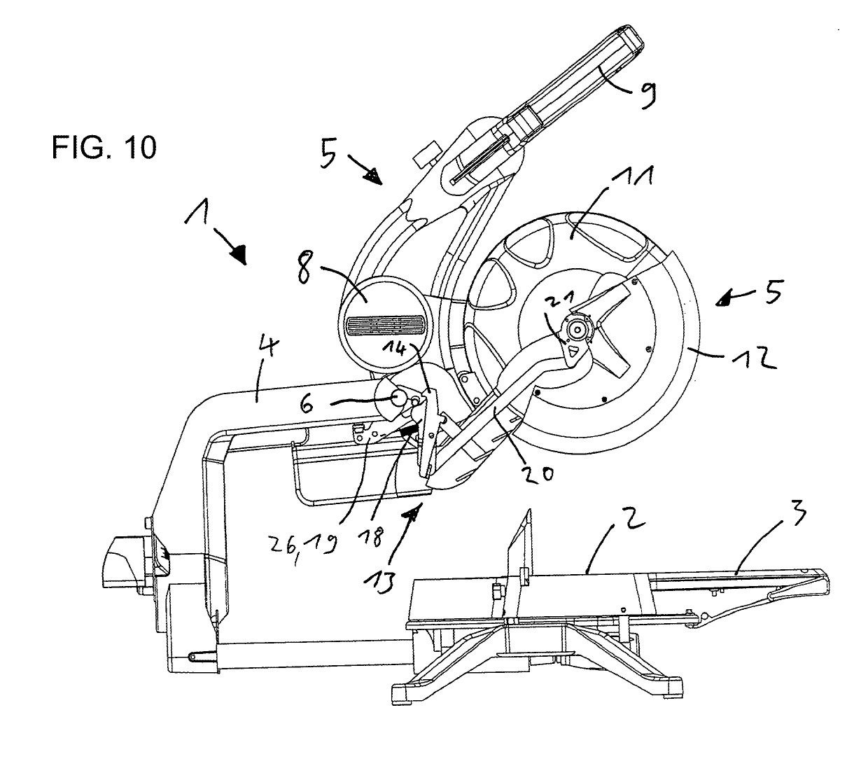

FIG. 10 shows a schematic side view, partly broken open, of the circular cross-cut saw from FIGS. 1 to 8, wherein the sawing device is arranged in an upper position and the swing guard is not open (closed), but is unlocked,

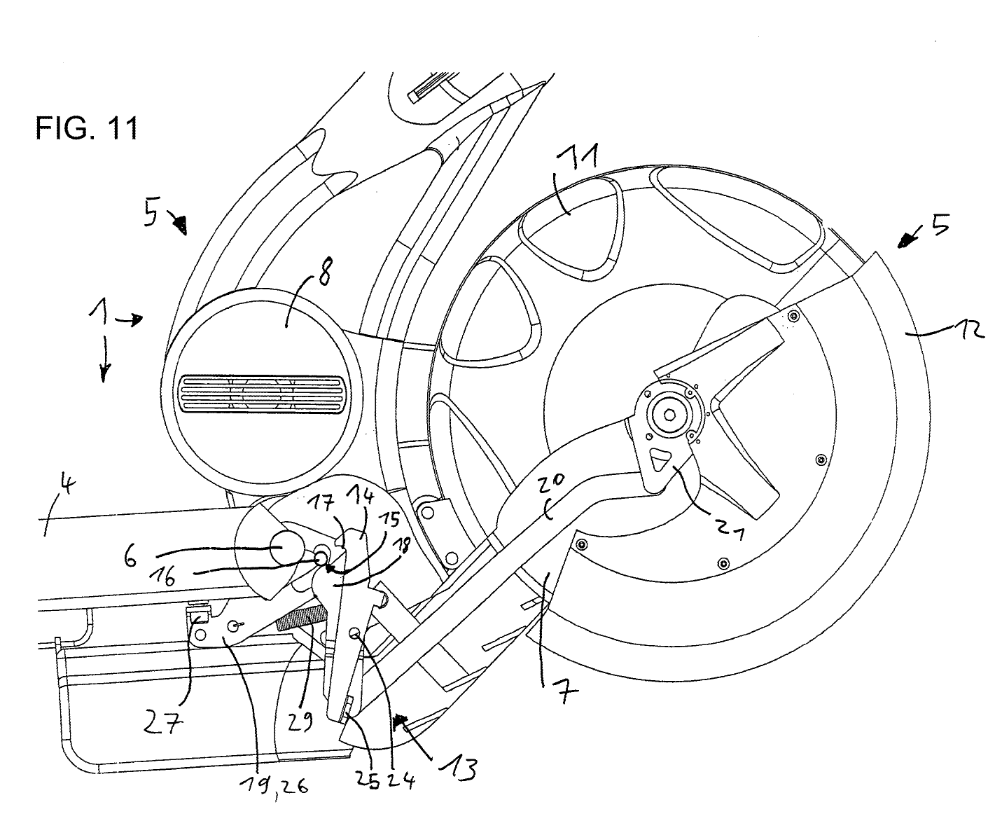

FIG. 11 shows a schematic view, partly broken open, of a detail of the circular cross-cut saw in the position shown in FIG. 10,

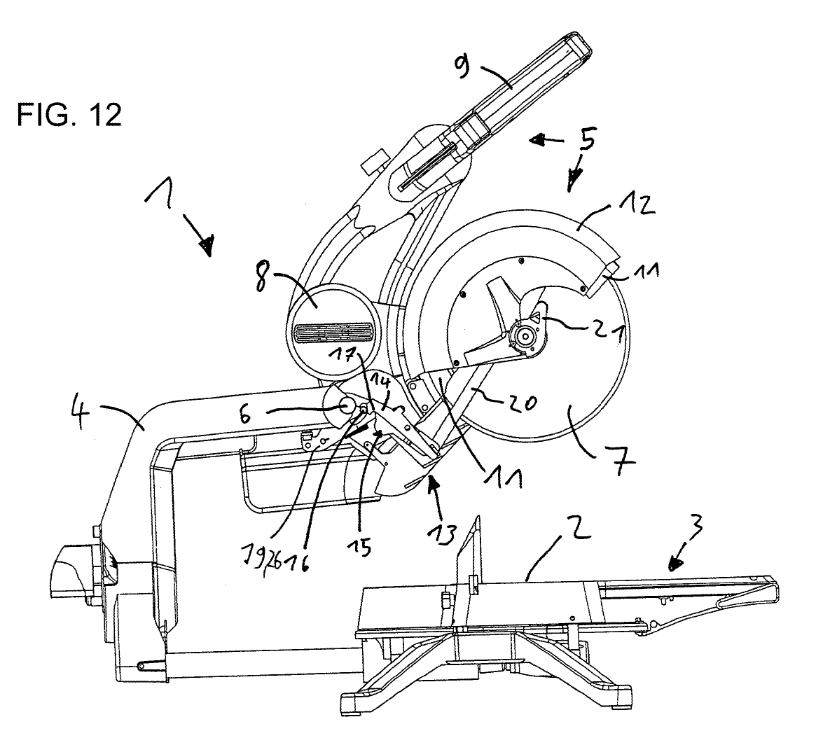

FIG. 12 shows a schematic side view, partly broken open, of the circular cross-cut saw from FIGS. 1 to 11, wherein, in the upper position of the sawing device, the swing guard is unlocked and fully open and

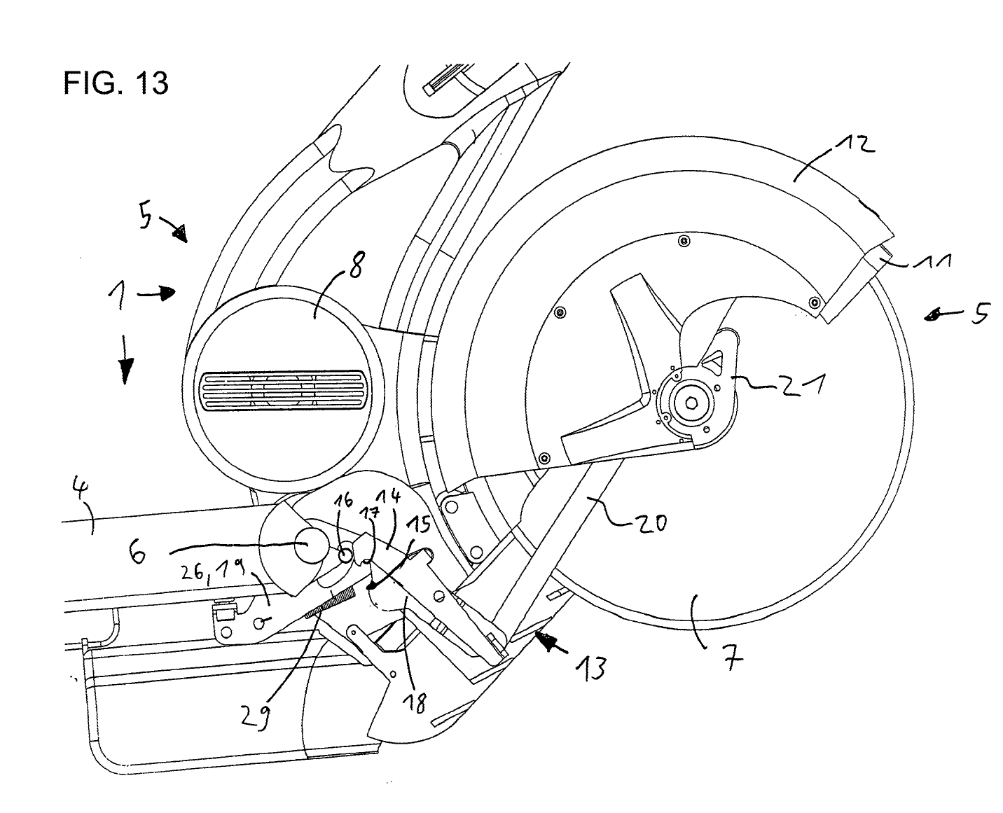

FIG. 13 shows a schematic representation, partly broken open, of a detail of the circular cross-cut saw from FIG. 12 in the position shown there.

A cross-cut saw 1 can be easily recognized and is shown schematically—at least in part—in FIGS. 1 to 13.

The circular cross-cut saw 1 is developed in particular as a miter saw (not shown in any more detail). The circular cross-cut saw 1 has a supporting table 2. Using the circular cross-cut saw 1, workpieces (not shown) such as strips, panels or sheets can be cut to the desired length. To this end, said workpieces are placed onto the supporting table 2 or in particular are arranged crosswise. The workpieces then extend with their longitudinal axes in a crosswise manner on the supporting table 2. The supporting table 2 has a top side (not shown in any more detail), wherein the top side is used for the workpiece (not shown) to rest on.

The circular cross-cut saw 1, preferably developed as a miter saw, also has a rotating means 3 which is pivotable about a vertical axis (not shown) in relation to the supporting table 2. The rotating means 3 is arranged so as to be rotatable about the vertical axis in relation to the supporting table 2. The rotating means 3 is rotatably mounted on a base plate (not shown in any detail). The rotating means 3, in this case, extends in part below the supporting table 2.

The circular cross-cut saw 1 also has an arm 4, which is connected with the rotating means 3 so as to be operatively effective. The arm 4 is preferably connected to the rotating means 3 by means of a pivot joint (not shown in any more detail) and/or a sliding guide device, as a result of which the cross-cut saw 1 provides a further pivoting possibility and/or pulling function. The arm 4 is pivotable about the vertical axis together with the rotating means 3.

The circular cross-cut saw 1 also has a sawing device 5, wherein the sawing device 5 is arranged above the supporting table 2. The sawing device 5 is arranged on the arm 4. The sawing device 5, in this case, is arranged so as to be pivotable about a cross-cutting axis 6. The cross-cutting axis 6, in this case, extends crosswise to the arm 4—preferably substantially horizontally—depending on the position of the arm 4. In an alternative development (not shown), the sawing device 5 can be arranged non-rotationally on the arm 4 and the arm 4 can be arranged together with the sawing device 5 so as to be pivotable about a cross-cutting axis.

The sawing device 5 has a saw blade 7. The saw blade 7, in this case, is preferably driven by an electric motor which is also associated with the sawing device 5 (not shown in detail). FIG. 1 shows, for example, a motor housing 8 of the electric motor for driving the saw blade 7. The sawing device 5 also has an actuating handle 9 in particular with several actuating switches 10 (cf. FIG. 1). A user of the circular cross-cut saw 1 is able to pivot the sawing device 5 up or down about the cross-cutting axis 6 by means of the actuating handle 9.

The sawing device 5 has a blade guard 11. When viewed in relation to the actuating handle 9 and to the motor housing 8, the blade guard 11 is stationary. The sawing device 5 also has a swing guard 12. The swing guard 12 is arranged so as to be pivotable in relation to the blade guard 11. The blade guard 11 covers the upper part of the saw blade 7. The swing guard 12 covers the lower part of the saw blade 7. The swing guard 12, in a closed position, conceals the lower part of the saw blade 7, in particular completely (cf. FIG. 2, FIG. 3, FIG. 10, FIG. 11). In an open position, the swing guard 12 exposes the lower part of the saw blade 7 in a substantially complete manner (cf. FIG. 8, FIG. 9, FIG. 12, FIG. 13). The swing guard 12 is then pivoted substantially over the blade guard 11.

The cross-cutting movement of the sawing device 5 is coupled to the rotating and/or pivoting movement of the swing guard 12 by means of a pivoting mechanism 13 in such a manner that the swing guard 12 can be opened by pivoting down the sawing device 5 (coupling movement) and can be closed by pivoting up the sawing device 5 (cf. FIG. 2 to FIG. 13).

The aforedescribed disadvantages are now avoided in that the pivoting mechanism 13 has a locking element 14, wherein the pivoting mechanism 13 and the locking element 14 are arranged and/or designed in such a manner that the swing guard 12—preferably manually or preferably by means of a workpiece provided to be cut—can be opened even further, in particular fully, when either the locking element 14 is actuated or the cross-cutting movement has already been carried out at least in part.

The advantage of this, among others, is that preferably for up to half of the cross-cutting movement it is true the swing guard 12 is already partly open, but it is not able to be fully opened by hand unless the locking element 14 is or will be also actuated separately by hand. In the lower region of the cross-cutting movement, the swing guard 12 is preferably opened even further and is additionally able to be opened fully by hand or by contact with a corresponding workpiece without the locking element 14 having to be actuated. Consequently, in the lower part of the cross-cutting movement, the locking element 14 has no function or does not block the opening operation of the swing guard 12. The method of operation of the pivoting mechanism 13 and of the locking element 14 can be explained in more detail below:

The pivoting mechanism 13 has a control cam 15 and a control means 16 interacting with the control cam 15 in order to control the pivoting movement of the swing guard 12. The control means 16 is moved at the start of the cross-cutting movement of the sawing device 5 along the control cam 15. The development of the control cam 15, in this case, determines the opening of the swing guard 12 as a function of the position of the sawing device 5. The locking element 14 is then in a blocking position or is arranged and/or can be arranged so as to block or to lock such that the locking element 14 strikes against the control means 16 when a manual attempt is made to open the swing guard 12 fully if the cross-cutting movement has only been carried out in part. If more than, in particular, 50%, preferably more than 70% of the cross-cutting movement has been carried out, the locking element 14 no longer strikes the control element 16 when the swing guard 12 is opened (by hand or through contact with a workpiece). During the upper part of the cross-cutting movement, the locking element 14 makes a stop member 17 ready to interact with the control means 16 if the swing guard 12 is opened by hand. The control means 16 is preferably realized as a pin. As an alternative, the control means 16 can be designed as a pin with an additional roller (not shown). The control means 16, in particular pin-shaped, is arranged at a spacing from the cross-cutting axis 6. The control means 16 is associated in a non-rotational manner with the sawing device 5. The sawing device 5, consequently, has the control means 16. When the sawing device 5 is pivoted, the control means 16 is consequently pivoted about the cross-cutting axis 6. The control cam 15 is realized on a control lever 18. The control lever 18 is arranged at one end so as to be pivotable on a pivot base 19, preferably via a bolt 30. The pivot base 19 is secured, in particular fastened so as to be adjustable/settable on an arm 4. At the other end, the control lever 18 interacts with a connecting rod 20, wherein the connecting rod 20 cooperates in an operatively effective manner with the swing guard 12. The control lever 18 is pivotally connected to the connecting rod 20.

The connecting rod 20, in this case, cooperates with a rotatable plate 21, wherein the rotatable plate 21 is non-rotationally connected to the swing guard 12. The connecting rod 20, in this case, is pivotally connected to the rotating plate 21. The connecting rod 20 cooperates eccentrically with the swing guard 12 or eccentrically with the rotating plate 21, wherein the swing guard 12, in opposition to a spring force of a spring (not shown) arranged in the region of the rotating plate 21, is pivotable or rotatable in a counter-clockwise manner in the open position.

The pivot base 19 of the pivoting mechanism 13 is secured to the arm 4 as follows: The pivot base 19, in this case, is mounted on the cross-cutting axis 6 by way of a corresponding cross-cutting opening 22 (cf. FIG. 1). Concentrically to the cross-cutting opening 22, the pivot base 19 also has an elongated hole 23 which extends in the shape of a circle segment (cf. FIG. 1). The pin-shaped control means 16 penetrates said elongated hole 23. The pivot base 19 is not also pivoted when the sawing device 5 is pivoted, but the control means 16 is able to be moved within the elongated hole 23 in relation to the pivot base 19.

The pivoting mechanism 13 preferably has the pivot base 19, the control lever 18 which is pivotally connected to the pivot base 19 and the connecting rod 20 which is pivotally connected, in its turn, to the control lever 18, wherein the connecting rod 20 cooperates in an operatively effective manner, eccentrically on the swing guard 12. In addition, the pivoting mechanism 13, as shown, can have the rotating plate 21 or as an alternative can cooperate directly with the swing guard 12.

The swing guard 12 is “restrictedly guided” in the upper part of the cross-cutting movement. In the lower part of the cross-cutting movement, preferably from approximately 50%, in particular from 70% of the cross-cutting movement, in the downward direction, the movement of the swing guard 12 can still basically be guided by the control cam 15, but is no longer restrictedly guided as the locking element 14 loses its function here, in particular the stop member 17 is no longer able to strike against the control means 16. The swing guard 12 is consequently an “open restrictedly guided” swing guard 12. This means that in the upper part of the cross-cutting movement, the swing guard 12 is locked with the aid of the locking element 14, i.e. it cannot be fully opened manually, wherein in the lower part of the cross-cutting movement, the locking element 14 no longer has any influence here, i.e. the swing guard 12 is unlocked such that the swing guard 12 can be opened even further, in particular fully by hand.

The opening movement of the swing guard 12 during the cross-cutting movement or during the feed movement of the sawing device 5 is restrictedly guided from top to bottom in that the control cam 15 of the control lever 18 abuts against the control means 16. During the cross-cutting movement, the control means 16, in this case, is also pivotable downward non-rotationally as a part of the sawing device 5. The pin-shaped control means 16 can be fastened, in particular, on the motor housing 8. The motor housing 8 pivots with the rest of the sawing device 5 about the cross-cutting axis 6. In the upper position of the sawing device 5, the control lever 18 is not readily able to pivot about the pivot base 19, as the mobility of the control lever 18 is restricted by the preferably hook-shaped stop member 17 of the locking member 14 on account of the position/positioning of the locking element 14.

I.e. the stop member 17 strikes against the control means 16 if the sawing device 5 is in an upper position and if an attempt is made to open the swing guard 12 fully by hand in this position. The stop member 17 extends preferably in the shape of a hook above the control cam 15. When an attempt is made to open the swing guard 12 by hand, with the sawing device 5 in an upper position, the stop member 17 strikes against the control means 16, as a result of which the opening movement of the swing guard 12 is stopped and blocked, as this also blocks the control lever 18 from moving counter-clockwise. In the case of such an attempt to open the swing guard 12, the pin-shaped control means 16 hooks further into the locking element 14 or the stop member 17 when a corresponding attempt is made, which prevents an opening of the swing guard 12 in the upper position of the sawing device 5 or also during the upper part of the cross-cutting movement. The swing guard 12 can namely only be opened by a pivoting of the control lever 18 counter-clockwise about the pivot base 19 and by a corresponding pivoting movement of the connecting rod 20 together with the control lever 18.

Reference is made to the detail shown in FIGS. 3, 5, 7, 9, 11 and 13:

When the cross-cutting operation is introduced, the control means 16 slides along the control cam 15 of the control lever 18 such that the control lever 18—rotating counter-clockwise in FIGS. 3, 5, 7, 9, 11 and 13—is moved counter-clockwise in opposition to the cross-cutting movement of the sawing device 5. The interaction of the control cam 15 and the control means 16 means that the swing guard 12 can be opened and is also rotated or pivoted counter-clockwise.

The control cam 15 of the control lever 18 and the distance between the pin-shaped control means 16 and the cross-cutting axis 6 determines the opening speed of the swing guard 12. The further the cross-cutting movement is carried out, the greater the increase in the distance between the control means 16 and the stop member 17 of the locking element 14. When preferably approximately 70% of the cross-cutting movement has been carried out, the distance between the control means 16 and the stop member 17 is so great that the swing guard 12 is even able to be opened fully by hand or the shape or the thickness of the workpiece to be cut predetermines the opening angle without the stop member 17 of the locking element 14 still striking against the control means 16 when the control lever 18 is moved counter-clockwise. Between the uppermost position of the sawing device 5 and the position of the sawing device 5 when approximately 50%, preferably approximately 70% of the cross-cutting movement has been carried out, the swing guard 12 can only be opened partly if the locking element 14 is not actuated. The locking element 14 is pivotally mounted on an axis 24 on the control lever 18. On its end opposite the stop member 17, the locking element 14 also has a handling region 25. The handling region 25, in this case, is actuatable such that the stop member 17 of the locking element 14 is pivoted clockwise away from the control cam 15 or from the control means 16, such that the control means 16 no longer provides a boundary for the stop member 17 when the swing guard 12 is opened fully by hand. This means that the control lever 18 is then pivotable counter-clockwise and the locking element 14 is pivoted together with the control lever 18, but is not blocked by the control means 16.

FIGS. 2, 3, 10 and 11 show an upper position of the sawing device 5, wherein, in this case, the locking element 14 in FIGS. 2 and 3 is not actuated and in FIGS. 10 and 11 it is actuated and consequently the swing guard 12 is locked in FIGS. 2 and 3 and unlocked in FIGS. 10 and 11. Through actuation of the handling region 25, the stop member 17 of the locking element 14 can be pivoted back to the right and can thus release the control means 16. The swing guard 12 cannot be opened fully in the upper position until this has happened. Thus, for example, among other things, FIGS. 1 to 3 show well that, in this case, the locking element 14 is connected pivotally to the control lever 18 on the axis 24, wherein a spring element is operatively arranged between the locking element 14 and the pivot base 19. The spring element 29 prestresses the locking element 14 counter-clockwise as a corresponding end of the spring element 19 cooperates with a projection/shoulder of the locking element 14 (not shown in any more detail). On account of the continuation/shoulder (not shown in this case) of the locking element 14, the movement of the locking element 14 counter-clockwise is also limited as said continuation/shoulder strikes against or abuts against the control lever 18 in a limiting manner.

FIGS. 4 and 5 show a central position of the sawing device 5 and of the swing guard 12. The swing guard 12 is only able to be opened manually a few degrees (for instance 10°) before the stop member 17 strikes against the control means 16. It is only possible to open the swing guard 12 fully when the stop member 17 is pivoted back by actuating the locking element 14 and thus is no longer able to come into contact with the control means 16.

FIGS. 6 and 7 show a position of the sawing device 5 in which the saw blade 7 is lowered as far as the supporting table 2. The swing guard 12 rests on the supporting table 2 and can still preferably be opened further by hand or the shape or thickness of a workpiece (not shown here) predetermines the opening angle of the swing guard 12. In this position, the control means 16 no longer abuts against the control cam 15, even if this is not shown clearly in detail in FIGS. 6 and 7.

In FIGS. 8 and 9, the sawing device 5 is shown in the same position as in FIGS. 6 and 7, namely in the lower lowered position, however the swing guard 12 here is fully open. The rotating plate 21, together with the swing guard 12, is rotated by a corresponding angle in comparison with FIG. 7.

FIGS. 10, 11, 12 and 13 show the circular cross-cut saw 1, wherein the sawing device 5 is arranged in an upper position. At the same time in FIGS. 10 and 11 the locking element 14 is shown in its open position, but the swing guard 12 is still in its closed position. In FIGS. 12 and 13, the swing guard 12 is pivoted away from the saw blade 7, i.e. is arranged in its open position. It can be seen particularly well from FIG. 11 that in the actuated position shown there of the locking element 14, the stop member 17 of the locking element 14 no longer obstructs the pivoting movement of the control lever 18, i.e. proceeding from the position shown in FIG. 11, the control lever 18 is able to be pivoted about the pivot base 19, as a result of which the swing guard 12 is pivoted up over the blade guard 11. This is only possible here with the locking element 14 actuated. The swing guard 12 is preferably prestressed in a spring-loaded manner. The swing guard 12 preferably has to be secured in this position because otherwise, by means of a spring force, the swing guard 12 automatically closes again and locks.

A further particularly preferred development of the invention relates to the pivot base 19. The disadvantage of the swing guards known in the prior art is that these swing guards do not close carefully. In order to solve this problem, the pivot base 19, in this case, is arranged on the cross-cutting axis. The pivot base 19 is arranged in particular so as to be displaceable on the cross-cutting axis 6. The pivot base 19 is adjustably fastened at its one end—a first arm 26—on the arm 4 of the circular cross-cut saw. To this end, the position of the arm 26 of the pivot base 19 is adjustable with an adjusting screw 27 (cf. FIG. 1) in relation to the arm 4 of the circular cross-cut saw 1. The pivot base 19 has another arm 28 at the other end. The control lever 18 is arranged so as to be pivotable on said arm 28. Consequently, by adjusting the position of the arm 26, the position of the arm 28 and consequently of the control lever 18 can be adjusted in relation to the control means 16. Adjusting the adjusting screw 27 improves the closing performance of the swing guard 12.

### LIST OF REFERENCES

1 Cross-cut saw
2 Supporting table
3 Rotating means
4 Arm
5 Sawing device
6 Cross-cutting axis
7 Saw blade
8 Motor housing
9 Actuating handle
10 Actuating switch
11 Blade guard
12 Swing guard
13 Pivoting mechanism
14 Locking element
15 Control cam
16 Control means
17 Stop member
18 Control lever
19 Pivot base
20 Connecting rod
21 Rotating plate
22 Cross-cutting axis opening
23 Elongated hole
24 Axis
25 Handling region
26 Arm
27 Adjusting screw
28 Arm
29 Spring element
30 Bolt

1-15. (canceled)

16. A circular cross-cut saw, comprising:
a supporting table;
a sawing device pivotally mounted about a cross-cutting axis, said sawing device having a saw blade and a displaceable swing guard;
a pivoting mechanism configured to cause a rotating and/or pivoting movement of said swing guard during a cross-cutting movement of said sawing device, with said swing guard opening at least in part by pivoting down said sawing device and closing by pivoting up said sawing device;
said pivoting mechanism having a locking element, wherein said pivoting mechanism and said locking element are configured to enable said swing guard to be opened even further when either said locking element is actuated or the cross-cutting movement has already been carried out at least in part.

17. The circular cross-cut saw according to claim 16, wherein said swing guard may be further opened by hand or by way of a workpiece to be cut when said locking element is actuated or the cross-cutting movement has already been carried out at least in part.

18. The circular cross-cut saw according to claim 16, wherein said sawing device is pivotable into an upper position and, by carrying out the cross-cutting movement, is pivotable into a lower position different from the upper position.

19. The circular cross-cut saw according to claim 16, wherein in the upper position of said sawing device, with said swing guard closed, said swing guard is locked to prevent an unintended opening of said swing guard, where said swing guard is opened without separately actuating said locking element.

20. The circular cross-cut saw according to claim 16, wherein after carrying out a certain part of the cross-cutting movement of said sawing device from the upper position into a lower position, the locking of said swing guard is automatically lifted on account of the cross-cutting movement already carried out, in that said locking element no longer prevents further opening of said swing guard.

21. The circular cross-cut saw according to claim 20, wherein said swing guard is automatically unlocked after carrying out the cross-cutting movement of more than 50% of the pivoting range.

22. The circular cross-cut saw according to claim 16, wherein the opening of said swing guard may be effected manually or by pressing against a workpiece.

23. The circular cross-cut saw according to claim 16, wherein said pivoting mechanism includes a control cam and a control means that interacts with said control cam, wherein when the cross-cutting movement is being carried out, said control means is moved at least partly along said control cam in order to control the pivoting movement of said swing guard.

24. The circular cross-cut saw according to claim 23, wherein said pivoting mechanism comprises a control lever and said control cam is formed on said control lever.

25. The circular cross-cut saw according to claim 24, wherein said control lever is pivotally connected to a connecting rod and said connecting rod is configured to cooperate with said swing guard eccentrically so as to be operatively effective.

26. The circular cross-cut saw according to claim 23, wherein said pivoting mechanism comprises a pivot base arranged non-rotationally with respect to said sawing device, and wherein said control lever is pivotally connected to said pivot base.

27. The circular cross-cut saw according to claim 26, wherein said sawing device is pivotally mounted on an arm and said pivot base is disposed on said arm.

28. The circular cross-cut saw according to claim 23, wherein said locking element includes a stop member configured to interact with said control means.

29. The circular cross-cut saw according to claim 24, wherein said locking element is arranged so as to be pivotally displaceable on said control lever and said locking element includes a handling region.

30. The circular cross-cut saw according to claim 26, wherein said pivot base is disposed on the cross-cutting axis.

31. The circular cross-cut saw according to claim 26, which comprises a control mechanism on said pivot base enabling the closed position of said swing guard to be adjustable.

32. The circular cross-cut saw according to claim 29, wherein said control mechanism includes an adjusting screw.

33. The circular cross-cut saw according to claim 16, wherein in the upper part of the cross-cutting movement said locking element in its locked position prevents complete opening of the swing guard and in that in the lower, remaining part of the cross-cutting movement, the locking element enables full opening of said swing guard.

34. The circular cross-cut saw according to claim 31, wherein said locking element remains locked for less than 50% of the cross-cutting movement.

35. The circular cross-cut saw according to claim 16, configured as a miter saw.
